(19) United States
(12) Patent Application Publication
(10) Pub. No.: US 2026/0246964 A1
(43) Pub. Date: Aug. 20, 2026

(54) A CODING METHOD OR APPARATUS BASED ON CAMERA MOTION INFORMATION

(71) Applicant: InterDigital CE Patent Holdings, SAS, Paris (FR)

(72) Inventors: Sylvain Thiebaud, Noyal sur Vilaine (FR); Tangi Poirier, Thorigne-Fouillard (FR); Saurabh Puri, Saint-Lazare (CA); Guillaume Boisson, Pleumeleuc (FR)

(21) Appl. No.: 19/138,023

(22) PCT Filed: Dec. 8, 2023
(86) PCT No.: PCT/EP2023/084860

§ 371 Date: Jun. 11, 2025

(30) Foreign Application Priority Data
Dec. 12, 2022 (EP) 22306847.9

(51) Int. Cl. H04N 19/513; A63F 13/355; A63F 13/52; H04N 19/139; H04N 19/176; H04N 19/196; H04N 19/59

(52) U.S. Cl. CPC H04N 19/521; A63F 13/52; H04N 19/139; H04N 19/176; H04N 19/196; H04N 19/59; A63F 13/355

(57) ABSTRACT

At least a method and an apparatus are presented for efficiently encoding or decoding video. For example, motion information is determined that is representative of camera motion between a current image and a reference image, where the current image and the reference image are part of a game engine 2D rendered video. For instance, motion information is determined for at least one sample in the coding block of the current image coded in inter with respect to a reference image from a depth model for the coding block and the camera parameters. For instance, at least one parameter of a depth model for the coding block is obtained, where the depth model includes a plane representative of depth values. The camera motion information is utilized in the encoding or decoding of the block.

### CROSS REFERENCE TO RELATED APPLICATIONS

This application claims the benefit of European Patent Application No. 22306847.9, filed on Dec. 12, 2022, which is incorporated herein by reference in its entirety.

### TECHNICAL FIELD

At least one of the present embodiments generally relates to a method or an apparatus for video encoding or decoding, and more particularly, to a method or an apparatus comprising determining motion information representative of camera motion.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

To obtain coding gains, modern codec standards define more and more sophisticated tools, and let the codec encoder decide the best ones to use. In the scope of cloud gaming compression, minimizing the latency is key. Although intensive computation capabilities are required in recent encoders that introduce a latency between the rendering of the game content and its coding.

Existing methods for coding and decoding show some limitations in the domain of coding 2D rendered video of a game engine. Therefore, there is a need to improve the state of the art.

### SUMMARY

The drawbacks and disadvantages of the prior art are solved and addressed by the general aspects described herein.

According to a first aspect, there is provided a method. The method comprises video encoding by obtaining a coding block in a current image, where the current image is part of a game engine 2D rendered video; obtaining at least one parameter of a depth model for the coding block, where the at least one parameter of the depth model define a plane representative of depth values; obtaining camera parameters for the current image and for the reference image; determining motion information for at least one sample in the coding block of the current image to be coded in inter with respect to a reference image, where motion information is determined from the at least one parameter of the depth model for the coding block and the camera parameters, where motion information is representative of camera motion between the current image and the reference image; and encoding the coding block based on the motion information.

According to another aspect, there is provided a second method. The method comprises video decoding by obtaining a coding block in a current image, where the current image is part of a game engine 2D rendered video; obtaining at least one parameter of a depth model for the coding block, where the at least one parameter of the depth model defines a plane representative of depth values; obtaining camera parameters for the current image and for the reference image; determining motion information for at least one sample in the coding block of the current image coded in inter with respect to a reference image, where motion information is determined from the at least one parameter of the depth model for the coding block and the camera parameters, and where motion information is representative of camera motion between the current image and the reference image; and decoding the coding block based on the motion information.

According to another aspect, there is provided an apparatus. The apparatus comprises one or more processors, wherein the one or more processors are configured to implement the method for video encoding according to any of its variants. According to another aspect, the apparatus for video encoding comprises means for implementing the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, wherein a depth model for the coding block includes a plane and is characterized by one, two or three depth parameters.

According to another general aspect of at least one embodiment, wherein the depth model for the coding block is signaled from the encoder to the decoder.

According to another general aspect of at least one embodiment, the camera parameters are representative of a position and characteristics of a game engine virtual camera capturing an image of the game engine 2D rendered video.

According to another general aspect of at least one embodiment, a depth value determined from the depth model is representative of a depth of a 3D point in a 3D scene corresponding to a current sample in a current image of the game engine 2D rendered video. Advantageously the determined depth value provides an estimate of the real depth of a 3D point in a 3D scene in the game engine.

According to another general aspect of at least one embodiment, an indication of a depth model associated with the coding block among a plurality of depth models is signaled form the encoder to the decoder.

According to another general aspect of at least one embodiment, an indication of camera motion information associated with the coding block is signaled from the encoder to the decoder.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates an example texture frame of a video game with a corresponding depth map.

FIG. 5 illustrates an example architecture of a cloud gaming system.

FIG. 6 illustrates a generic encoding method according to a general aspect of at least one embodiment.

FIG. 7 illustrates a generic decoding method according to a general aspect of at least one embodiment.

FIG. 8 illustrates 4 exemplary representations of a plane of a depth model according to at least one embodiment.

FIG. 9 illustrates a camera motion inter tool in a codec according to a general aspect of at least one embodiment.

FIG. 10 illustrates principles of a determination of a depth value in a 2 parameters' depth model according to a general aspect of at least one embodiment.

FIG. 11 illustrates principles of a determination of a depth value in a 3 parameters' depth model according to a general aspect of at least one embodiment.

FIG. 12 illustrates principles of a pinhole camera model of a virtual camera in a cloud gaming system.

FIG. 13 illustrates projection planes of a virtual camera in a cloud gaming system.

FIG. 14 illustrates 2D to 3D transformations according to a general aspect of at least one embodiment.

### DETAILED DESCRIPTION

Various embodiments relate to a video coding system in which, in at least one embodiment, it is proposed to adapt video coding tools to the cloud gaming system. Different embodiments are proposed hereafter, introducing some tools modifications to increase coding efficiency and improve the codec consistency when processing 2D rendered game engine video. Amongst others, an encoding method, a decoding method, an encoding apparatus, a decoding apparatus based on this principle are proposed. Although the present embodiments are presented in the context of the cloud gaming system, they may apply to any system where a 2D video may be associated to with camera parameters, such as a video captured by mobile device along with sensor's information allowing to determine the position and characteristics of the device's camera capturing the video. Depth information may be made available either from a sensor or other processing.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

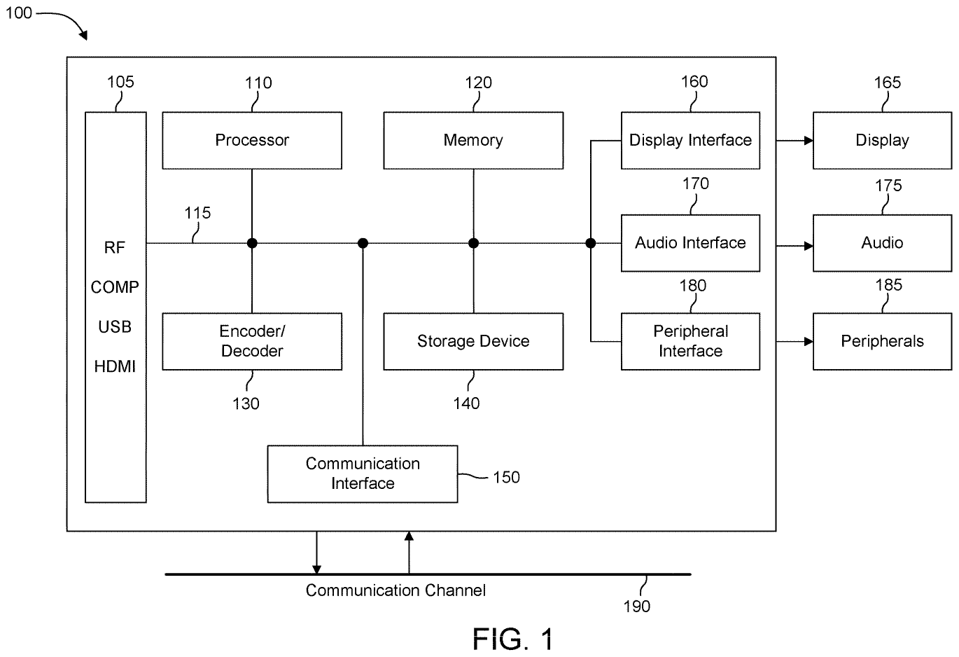

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna. Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

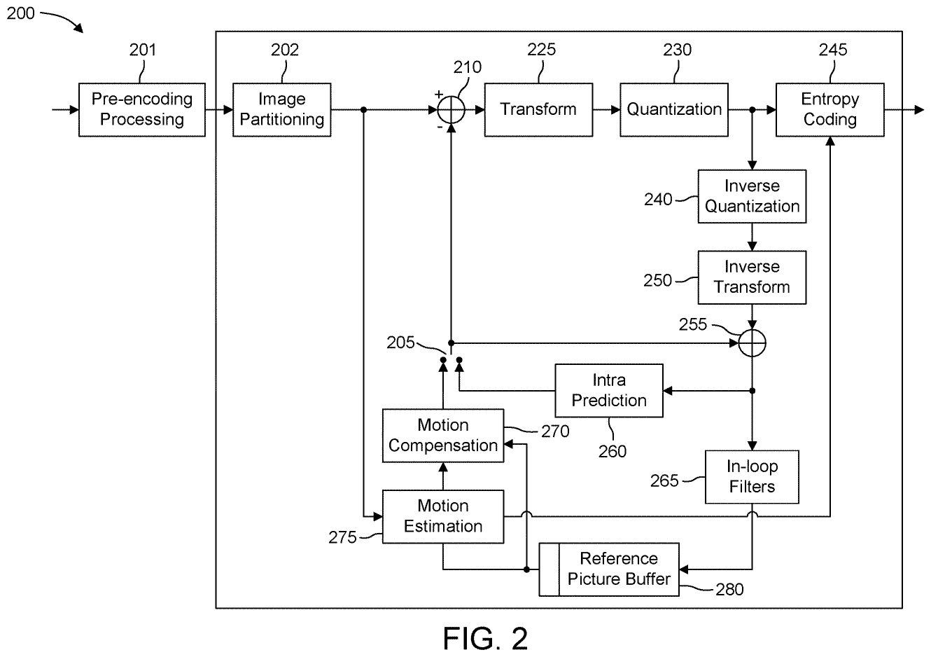

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240), and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

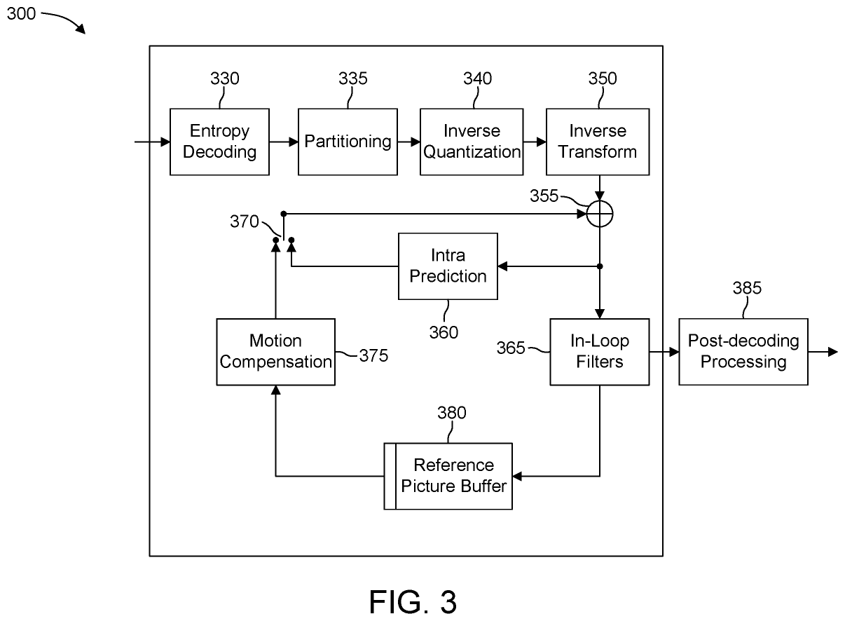

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340), and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

A video coding system such as a cloud gaming server or a device with light detection and ranging (LiDAR) capabilities may receive input video frames (e.g., texture frames) together with depth information (e.g., a depth map) and/or motion information, which may be correlated.

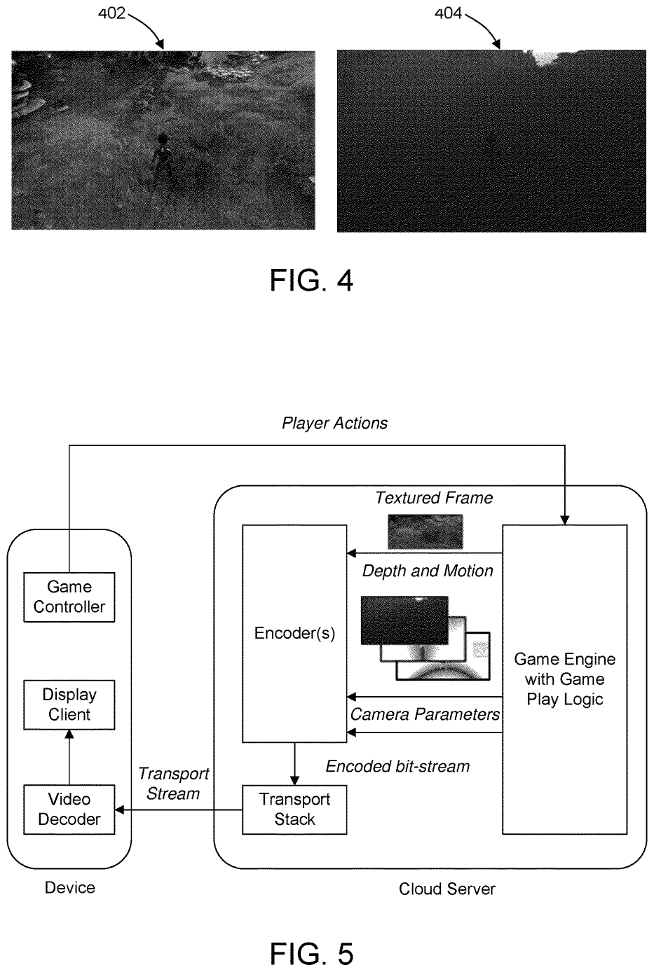

FIG. 4 illustrates an example texture frame 402 of a video game with a corresponding depth map 404 that may be extracted (e.g., directly) from a game engine that is rendering the game scene. A depth map may be provided by the game engine in a floating-point representation. A depth map may be represented by a grey-level image, which may indicate the distance between a camera and an actual object. A depth map may represent the basic geometry of the captured video scene. A depth map may correspond to a texture picture of a video content and may include a dense monochrome picture of the same resolution as the luma picture. In examples, the depth map and the luma picture may be of different resolutions.

FIG. 5 shows an example architecture of a cloud gaming system, where a game engine may be running on a cloud server. The gaming system may render a game scene based on the player actions. The rendered game scene may be represented as a 2D video including a set of texture frames. The rendered game engine 2D video may be encoded into a bitstream, for example, using a video encoder. The bitstream may be encapsulated by a transport protocol and may be sent as a transport stream to the player's device. The player's device may de-encapsulate and decode the transport stream and present the decoded 2D video representing the game scene to the player. As illustrated in FIG. 5, additional information such as a depth information, motion information, an object ID, an occlusion mask, camera parameters, etc. may be obtained from a game engine (e.g., as outputs of the game engine) and made available to the cloud server (e.g., an encoder of the cloud) as prior information. According to at least one embodiment, the video to encode is generated by 3D game engine as shown in the cloud gaming system of FIG. 5.

The information described herein such as the depth information, or camera parameters or a combination thereof may be utilized to perform motion compensation in the rendered game engine 2D video in a video processing device (e.g., the encoder side of a video codec). The motion compensation of the rendered game engine 2D video may be simplified utilizing such depth information associated to camera parameters while improving coding gains (e.g., compression gains). The new motion compensation based on the camera parameters is referred to as Camera Motion tool in the present disclosure. The Camera Motion tool allows predicting motion in areas of a current image where motion is only affected by the virtual camera of the game engine (its characteristics and position). Accordingly, a high degree of flexibility in the block representation of a video in a compressed domain may be implemented, e.g., in a way that there may be a limited increase in a rate distortion optimization search space (e.g., on an encoder side). Besides, as the inventors have recognized that sending a depth map to the decoder is not realistic in the scope of video content compression, at least one embodiment further relates to a Camera Motion tool that does not compute the motion vectors using the game engine's depth map, but using an approximation of the depth map for the coding block, the approximation being based on a parametric plane defined in a depth model.

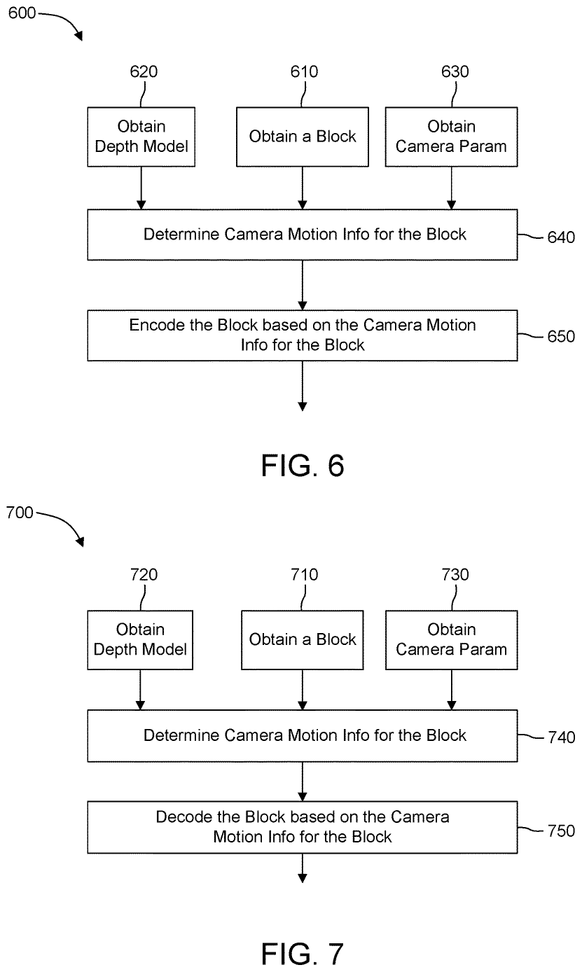

FIG. 6 illustrates a generic encoding method 600 according to a general aspect of at least one embodiment. The block diagram of FIG. 6 partially represents modules of an encoder or encoding method, for instance implemented in the exemplary encoder of FIG. 2.

According to preliminary steps not shown on FIG. 6, a game engine generates at least one image (texture image) of a 2D video, the rendered game engine 2D video, along with side information. According to non-limiting examples, side information may comprise depth information relative to game scene, or camera parameters of a virtual camera capturing the game scene. The depth information may include a depth map that may be extracted (e.g., directly) from a game engine that is rendering the game scene. A depth map may be coded in floating-point representation or represented by a grey-level image, as shown on FIG. 4, which indicates the distance between a virtual camera and an actual object. Thus, a depth map may represent the basic geometry of the captured video scene. A depth map may correspond to a texture image of a video content and may include a dense monochrome image of the same resolution as the luma image. The current image of the rendered game engine 2D video is partitioned and processed in blocks (or units) of, for example, coding blocks CBs or Coding Tree units CTUs (corresponding to a higher level of image partition in a codec). Each block is encoded using, for example, either an intra or inter mode. In an inter mode, motion estimation and compensation are performed. The encoding decides which one of a plurality of inter modes to use for encoding the block, and indicates the inter decision by, for example, signaling motion information to obtain an inter prediction block at the decoding. Motion models in current codec allow to account for various type of displacement between a current image and a reference image (i.e., translation or rotation) and motion models are usually agnostic the way the images were generated. However, while processing 2D video rendered by a game engine, there exist areas of the image where the content is only affected by the motion of the virtual camera and such content may represent the still environment of the scene. In a video game content, such areas may represent a significant part of the content. At least one embodiment relates to a novel motion model where motion information is representative of camera motion between the current image and the reference image. The camera motion information is determined from depth information and the camera parameters. To reduce the amount of information needed to signal depth information to a decoder, at least one embodiment further relates to a depth model which provides local approximation of the depth of a sample at the level of the coding block using planes in the 3D scene. For instance, 4 models corresponding to different orientation of a plane with respect to a camera's sensor may be utilized as depth models. An encoding method may determine, based on RDO, whether to encode a block using inter prediction among which a motion camera mode based on the Motion inter tool. Besides, an encoding method may determine, based on RDO, which depth model among a plurality of depth models is used to determine motion information representative of camera motion.

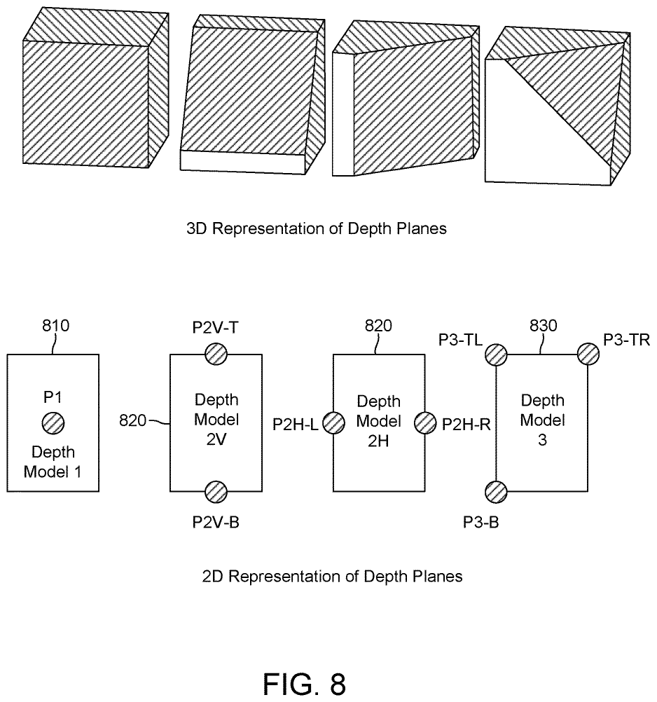

According to a first step 610, a coding block is obtained from a partitioning process of the current image. According to a second step 620, a depth model is determined for the coding block. As detailed hereafter with reference to FIG. 8, the depth model is representative of a plane representative of the 3D scene's depth. This depth model may for instance represent a plane fitting the depth map provided by the game engine at the level of the coding block. A depth model may be specified using one, two or three parameters according to the orientation of the plane with respect to the camera plane. Advantageously, the depth model provides a compact representation of the depth in the 3D scene that may be used to signal depth information to a decoder. According to a third step 630, camera parameters are obtained for instance from the game engine. For instance, the camera parameters are representative of the position and characteristics of a game engine virtual camera capturing the image of the game engine 2D rendered video. According to a variant, the 4×4 matrices representing the camera to world transformation are representative of the position and the orientation of the camera for a current image and the reference image. The 4×4 intrinsic matrices may represent the intrinsic parameters of the camera for these two images. Then in step 640, motion information is determined for at least one sample in the coding block of the current image to be coded in inter with respect to a reference image. A 3D point location is determined from the position of a sample in the current image, the depth value for that sample where the depth value is computed from the depth model and from the 2D to 3D inversion transformation characterized by the camera parameters. Then, the 3D point is projected onto the reference image using the 3D to 2D transformation characterized by the camera parameters of the reference image. The displacement of the sample between the position in the current image and its position in the reference image corresponds to the motion vector attached to that sample. Unlike state of the art motion estimation processes that perform block matching based on texture information between the current and the reference image to determine motion information, the present camera motion inter tool determines motion information based on information (camera parameters, depth parameters) relative to the capture of a 3D point that is not moving in 3D space but have a displacement due to its capture condition (i.e. the motion of the virtual camera between the current and the reference image). According to a variant, a plurality of depth models, such as Depth Models 1 to 4, along with depth model parameters may be put into competition in a Rate-Distortion Optimization process and the depth model with the associated parameters that results in the lower Rate-Distortion Cost may be selected by the encoder. According to another variant, Camera Motion Inter processing may be put into competition with other inter prediction processes (such as regular, affine, geo . . . ) at the encoder. Therefore, based on the camera motion information, in step 650, an inter prediction is obtained for the coding block. Then, also represented by 650, the differences between the original block and the predicted block, often denoted as prediction errors or prediction residuals, are transformed, quantized, and entropy coded. According to another variant embodiment, an indication of camera motion information is associated with the coding block when the encoder selects a camera motion inter prediction to encode the current block. According to another variant, the indication of camera motion information associated with the coding block is encoded. Thus, the indication is signaled to the decoder which made the decoder use camera motion inter tool to predict the coding block. According to yet another variant, an indication is encoded indicating that determining motion information representative of camera motion for a coding block is enabled in the current image. According to yet another variant, an indication of the selected depth model associated with the coding block among a plurality of depth models is signaled to from encoder to the decoder. According to yet another variant, the depth models' parameters are also signaled from the encoder to the decoder. The skilled in the art will appreciate, that the depth value determined from the depth model and depth model parameters may be different from the real depth value in the depth map provided by the game engine as the depth model results from the RDO and not from a direct representation of the depth map values.

FIG. 7 illustrates a generic decoding method 700 according to a general aspect of at least one embodiment. The block diagram of FIG. 7 partially represents modules of a decoder or decoding method, for instance implemented in the exemplary decoder of FIG. 3. As for the encoding method, according to a first step 710, a coding block to decode, namely the texture block, is obtained in the current image after entropy decoding, de-quantization and inverse transform. To reconstruct the coding block, an inter prediction is determined, for instance using the camera motion inter tool. According to a second step 720, a depth model is obtained for the coding block. As detailed hereafter with reference to FIG. 8, the depth model includes a plane representative of the depth in a 3D scene at the level of the coding block. For instance, a depth value is computed from the depth model and depth model parameters. The computed depth value is an estimate of the depth for a corresponding sample in the 3D space. A depth model may be specified using one, two or three parameters according to the orientation of the plane with respect to the camera plane. According to a third step 730, camera parameters are obtained. For instance, the camera parameters are representative of the position and characteristics of a game engine virtual camera capturing the image of the game engine 2D rendered video. According to a variant, 4×4 matrices representing the camera to world transformation are representative of the camera parameters for a current image and for the reference image. The 4×4 intrinsic matrices may represent the intrinsic parameters of the camera for these two images. In a variant, the camera parameters, and the depth models are encoded in the bitstream carrying encoded video. Then in step 740, motion information is determined for at least one sample in the coding block of the current image to be coded in inter with respect to a reference image. As explained for the encoding method, the displacement of a sample between its position in the current image and its position in the reference image corresponds to the motion vector attached to that sample. Therefore, based on the motion information obtained in 740, in step 750, an inter prediction is obtained for the coding block for instance using classical motion compensation. Then, also represented by 750, decoded residuals are combined with the inter predicted block, and filtered to provide a reconstructed coding block. According to another variant embodiment, an indication of camera motion information associated with the coding block is decoded. The indication informs the decoder on the inter prediction model used at the encoding, such as the camera motion inter process. According to yet another variant, an indication is decoded indicating that determining motion information representative of camera motion for a coding block is enabled in the current image.

Various embodiments of the generic encoding or decoding method are described in the following. According to at least one embodiment, the encoder/decoder performs motion compensation according to motion information representative of camera motion between the current image and the reference image. Advantageously such motion model provides an efficient method for inter predicting an area in a 2D image representing a 3D object without motion in the 3D space but that has apparent motion in 2D projected image due to camera motion. For instance, the camera motion compensation may be coupled with a classification of blocks into Camera Motion CBs and non-camera Motion CBs. Advantageously, the encoder may use this classification to make decisions. As an example, it may decide to code a Camera Motion CB with Camera Motion Tool. Thus, intensive computation capabilities required for encoder decision as well as latency introduced between the rendering of the game content and its coding are reduced. Unlike offline compression, in the scope of cloud gaming compression, minimizing this latency is key. The duration between a player's action and its consequences should be minimized.

FIG. 8 illustrates 4 exemplary representations of a plane of a depth model according to at least one embodiment. The hatched planes represent some planes in the 3D game scene which are only affected by the game engine's camera. Below these 3D hatched planes, an exemplary Camera Motion CB 810, 820, 830 corresponding to the projection of a part of the hatched planes by the camera is represented.

According to a first variant, a depth model for the coding block includes a plane parallel to a camera's sensor and is characterized by one depth parameter. In this variant, the plane 810 of the coding block may be approximated by a plane parallel to the camera's sensor, the coding block is represented by only one depth parameter (Depth Model1). The depth parameter represents the depth value of the central sample P1 in the coding block, which is also the depth value of any sample in the coding block.

According to a second variant, a depth model for the coding block includes a plane 820 tilted vertically or horizontally with respect to a camera's sensor and the depth model is characterized by two depth parameters. In this variant, the plane may either be tilted horizontally (Depth Model 2H implying a horizontal depth interpolation) or vertically (Depth Model 2V implying a vertical depth interpolation). In this case, two depth parameters are required to define the depth plane. For instance, for the Depth Model 2V, a first depth parameter represents a depth value of a central sample P2V-T on a top border line of the coding block and a second depth parameter represents a depth value of a central sample P2V-B on a bottom border line of the coding block. For instance, for the Depth Model 2H, a first depth parameter represents a depth value of a central sample P2H-L on a left border line of the coding block and a second depth parameter represents a depth value of a central sample P2H-R on a right border line of the coding block. Then, as detailed below, the depth of any sample in the coding block is determined using an interpolation between the depth values indicated by the two depth parameters.

According to a third variant, a depth model for the coding block includes a plane tilted vertically and horizontally with respect to a camera's sensor and the depth model is characterized by three depth parameters. In the variant, the plane is tilted in both directions (Depth Model 3) and three parameters are required. For instance, for the Depth Model 3, the three parameters respectively represent the depth value of a top-left sample P3-TL of the coding block, a depth value of a top-right sample P3-TR of the coding block, a depth value of a bottom-left sample P3-B of the coding block. The skilled in the art will appreciate that the positions of samples used in the depth plane model are non-limiting examples, and that the present principles may contemplate any implementation of depth parameters allowing to define the 4 plane models. The skilled in the art will further appreciate that although disclosed models are representative of a plane, more complex surface, such as a set of triangles or curves may be compliant with the present principles. In this variant, the parameters defining the surface and a depth value for any pixel in the coding block may be adapted.

Usually in state of art encoders, the motion compensation process consists in predicting the current block, thanks to motion vectors on reference images. A Rate-Distortion cost is computed for this motion compensation, providing an objective metric characterizing the coding cost and the quality of the prediction. The inter prediction tool (such as regular, affine, geometric partition including also the various embodiment of refinement of motion vectors, of the blending of predictions) providing the lower Rate-Distortion cost is usually selected by the encoder to code the block. Advantageously, the new Camera Motion tool consists in computing the motion vectors in a new way for game engine contents, wherein for each Camera Motion Depth Model as illustrated on FIG. 8, the following operations are performed on the current block. Firstly, for each sample of the block (or a sub-sampled set in the block, sub-sampling by 4 in both direction for instance), an estimate of the depth of a sample is computed depending on its position, the Camera Motion Depth Model and its associated parameters, where the depth in the coding block is represented with a parametric plane. Secondly, a motion vector is computed depending on the sample position, the estimate depth and the camera parameters.

According to a particular embodiment, the depth parameters used to approximate the depth map to planes are signaled to the decoder.

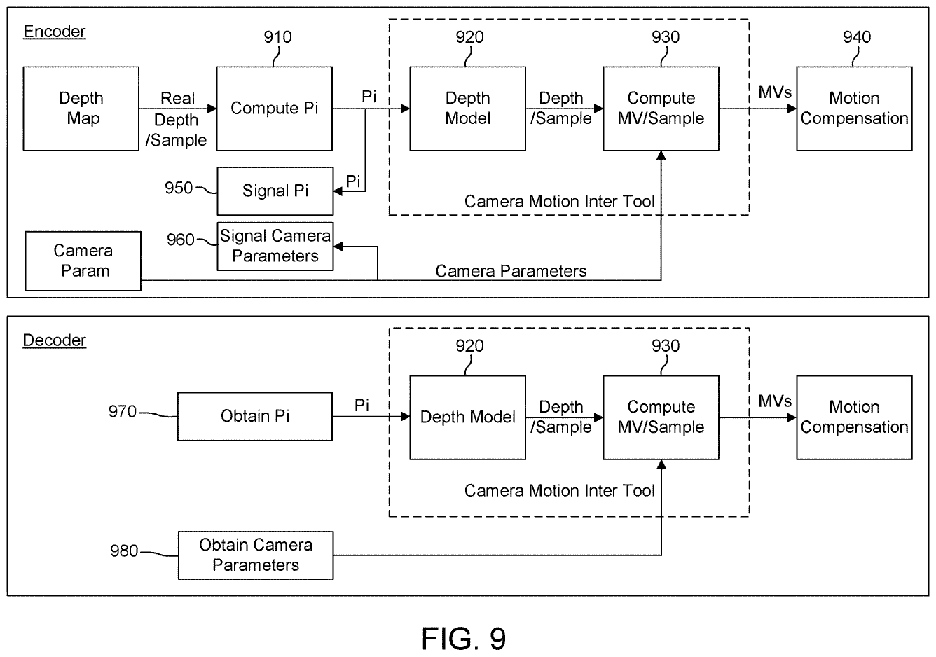

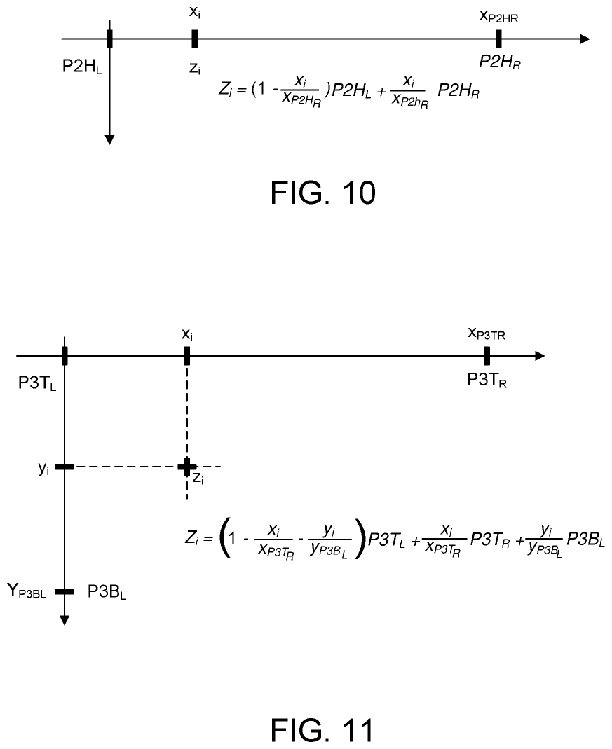

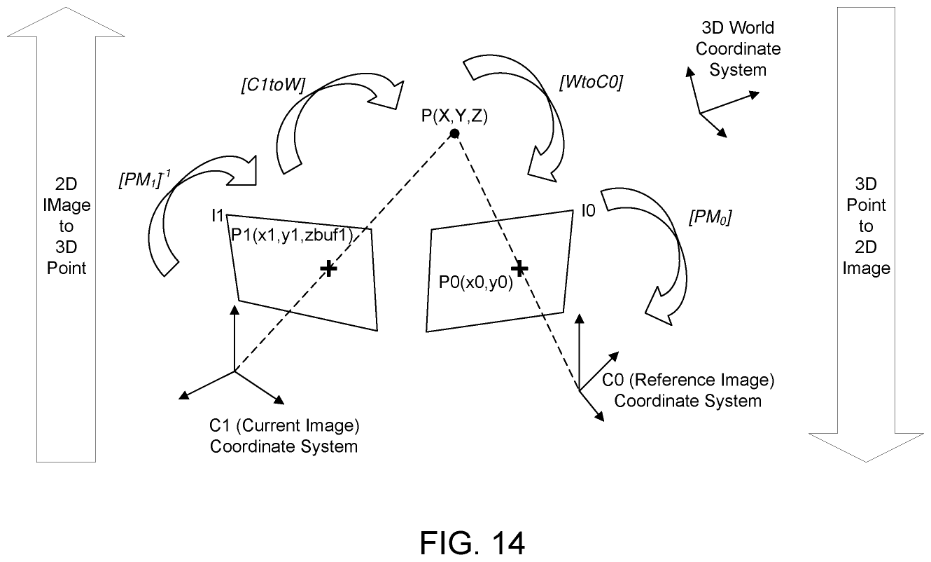

FIG. 9 illustrates a camera motion inter tool in a codec according to a general aspect of at least one embodiment. The block diagram of FIG. 9 partially represents modules of an encoder or encoding method, for instance implemented in the exemplary encoder of FIG. 2. The block diagram of FIG. 9 further partially represents modules of a decoder or decoding method, for instance implemented in the exemplary decoder of FIG. 3. For the encoder and the decoder, the Camera Motion inter tool 920, 930 is indicated by the dotted line in encoder and decoder scheme of FIG. 9. The Camera Motion inter tool receives some depth model parameters Pi along with camera parameters and provides motion vectors MVs used to compute the motion compensation. The game engine provides a 2D rendered image to the encode (not shown on FIG. 9 as the texture of the image is not used by the Camera Motion inter tool). As presented above, the game engine may also provide a depth map that may be used to compute the depth model parameters Pi and the camera parameters of its virtual camera to the encoder in the RDO loop. According to this embodiment, these 2 types of information are used to determine the Camera Motion motion vectors MVs. The camera parameters represent the characteristics and the position of the game engine's virtual camera. They are provided for the reference image and for the current image to be encoded. The depth information represents the depth of the 3D points of the game content for each sample (or pixel) of the current frame. In a preliminary step, the encoder determines 910 a depth parameter Pi for a depth model I from the depth map by approximating the depth at the coding block position with a plane. Depending on the depth model, the coding block depth is approximated with a plane characterized by up to 3 parameters Pi. For instance, for the Depth Model1 representing a block with constant depth, a single depth parameter P1 may be obtained by taking one of the depths of the central pixel of the coding block, an average depth around the central pixel of the coding block, or the average depth of the coding block, with or without sub-sampling. Variant embodiments of the depth map modelling 910 are described below. As the decoder should perform inverse operation to the encoder, the parameters Pi of the depth model are input to the camera motion inter tool of the encoder. Then, the encoder reconstructs 920 depth values of the coding block based on the depth model parameters Pi. It determines an estimation of the depth value of any sample of the coding blocks as described hereafter with FIGS. 10 and 11 based on Pi. A motion vector per sample is computed depending on its position, its approximated depth, and the camera parameters. This step is further detailed with reference to FIG. 14. Depending on the implementation, to reduce the complexity, a motion vector can be computed for a block of samples. For instance, in VVC, a motion vector is computed per block of 4×4 samples. These motion vectors are used to perform the motion compensation as known by the skilled in the art. Since this vector is computed with the depth and the camera parameters, it represents the displacement of the current sample between the reference frame and the current frame due to a camera motion (translations and/or rotations), or a modification of the camera's characteristics (focal length, . . . ). Different predictors issued from the Camera motion inter tool may be put into competition into a RDO loop to determine the motion model along with associated parameters that result in the lower rate distortion cost. Finally, the selected depth model and parameters Pi are signaled 950 to the decoder, as side information, as to be used at the input of to the camera motion inter tool 920, 930 of the decoders. The encoder also signals 960 camera parameters for the images.

On the decoder side, the Camera motion inter tool computes Camera Motion MVs as done in the encoder. To that end, the decoder obtains 970, for instance by decoding side information, the parameters Pi of the depth model of a coding block to decode. Additionally, the decoder obtains 980 camera parameters for the current image and for the reference image. The camera parameters for the reference image may be stored locally in the decoder at the reconstruction of the reference image.

In the following, at least one embodiment of the computation 920 of the approximated depth with the depth model and at least one embodiment of the computation 930 of the camera motion information are detailed.

The depth map as shown in FIG. 4 and in FIG. 5 is a representation of the depth of a point belonging to the 2D projected image. However, a depth value in the depth map does not directly represent the depth of a 3D point in the 3D scene. When a 3D point is projected to a 2D image, it is projected to an image position (x, y). Indeed, mathematically a third coordinate exists, however this third coordinate is dropped when considering depth in a 2D image, although it is stored in the game engine's Z buffer. Advantageously, the game engine generates the third coordinate called “zbuff” and gathers the zbuff coordinates associated to the 2D image in a depth map.

According to at least one embodiment, a depth value is determined based on the depth model representative of a plane providing an approximation of the coding block depth.

In a first variant, a depth model, Depth Model 1 of FIG. 8, includes a plane parallel to a camera's sensor and is characterized by one depth parameter. In this variant, since the depth is constant, it may be characterized by only one depth parameter P1. According to various embodiments, the depth parameter is determined from one of a depth value of a central sample of the coding block, an average depth value of a set of samples neighboring the central sample of the coding block, an average depth value of samples of the coding block, an average depth value of samples of a subsampled coding block. For instance, the depth values are obtained from the depth map corresponding to the current image. Since the depth is constant in the Depth Model 1, any sample of the coding block has an estimated depth value equal to the depth parameter P1.

In a second variant, a depth model, Depth Model 2V and Depth Model 2H of FIG. 8, a depth model for the coding block includes a plane tilted vertically or horizontally with respect to a camera's sensor and is characterized by two depth parameters. In the variant where the plane is tilted vertically, the depth parameters P2V-T and P2V-B may be respectively determined from one of a depth value of a central sample on a top and a bottom border lines of the coding block, an average depth value of a set of samples neighboring the central sample on the top and the bottom border lines of the coding block, an average depth value of samples on the top and the bottom border lines of the coding block, an average depth value of samples on the top and the bottom border lines of a subsampled coding block. In the variant where the plane is tilted horizontally, the depth parameters P2H-R and P2H-L are respectively determined from one of a depth value of a central sample on a left and a right border lines of the coding block, an average depth value of a set of samples neighboring the central sample on the left and the right border lines of the coding block, an average depth value of samples on the left and the right border lines of the coding block, an average depth value of samples on the left and the right border lines of a subsampled coding block.

FIG. 10 illustrates principles of a determination of a depth value in a 2 parameters' depth model according to a general aspect of at least one embodiment. For instance, in the variant Depth Model 2H or 2V, the depth of the current sample is computed by a linear interpolation between the two depth parameters. For the Depth Model 2V, this interpolation is performed vertically (the depth depends on the vertical position of the sample). For the Depth Model 2H, this interpolation is performed horizontally (the depth depends on the horizontal position of the sample in the coding block). For instance, as illustrated on FIG. 10, for the sample i located at the horizontal position xᵢ, the depth value Zᵢ is computed from the depth values P2H-L=P2H_{L} and P2H-R=P2H_{R} according to:

$${Z}_{i} = ( 1 - \frac{{x}_{i}}{{x}_{P 2 {H}_{R}}} ) P 2 {H}_{L} + \frac{{x}_{i}}{{x}_{P 2 {h}_{R}}} P 2 {H}_{R}$$

Where the left sample (having depth parameter P2H-L=P2H_{L}) has a horizontal position equal to 0, and where the right sample (having depth parameter P2H-R=P2H_{R}) have a horizontal position equal to X_{P2hR}.

In a third variant, a depth model, Depth Model 3 of FIG. 8, a depth model for the coding block includes a plane tilted both vertically and horizontally with respect to a camera's sensor and is characterized by three depth parameters. According to various embodiments, the three depth parameters are respectively determined from a depth value of a top-left sample of the coding block, a depth value of a top-right sample of the coding block, a depth value of a bottom-left sample of the coding block. According to another embodiment, the three depth parameters corresponding to a depth value of a top-left sample in the coding block, a depth value of a top-right sample in the coding block, a depth value of a bottom-left sample in the coding block are determined by minimizing an error between depth values from the depth map and from the plane of the depth model. In that case, the complexity of the depth modeling would be largely increased. The skilled in the art will appreciate that minimizing an error between the depth map and the depth plane may also apply to the 2 parameter-models.

FIG. 11 illustrates principles of a determination of a depth value in a 3 parameters' depth model according to a general aspect of at least one embodiment. As for the 2 parameter-model, a linear interpolation is performed in both directions as presented in FIG. 11.

For instance, as illustrated on FIG. 11, for the sample i located at the horizontal position xᵢ, and at the vertical position yᵢ, the depth value Zᵢ is computed from the depth values P3-TL=P3T_{L}, P3-TR=P3T_{R} and P3-B=P3B_{R} respectively for top-left sample TL, top-right sample TR and bottom-left sample BL according to:

$${Z}_{i} = ( 1 - \frac{{x}_{i}}{{x}_{P 3 {T}_{R}}} - \frac{{y}_{i}}{{y}_{P 3 {B}_{L}}} ) P 3 {T}_{L} + \frac{{x}_{i}}{{x}_{P 3 {T}_{R}}} P 3 {T}_{R} + \frac{{y}_{i}}{{y}_{P 3 {B}_{L}}} P 3 {B}_{L}$$

Where the top-left sample TL has coordinates (0, 0), the top-right sample TR has coordinates (x_{P3TR}, 0) and the bottom-left-sample BL has coordinates (0, y_{P3BL}).

Once the approximated depth of the third coordinate “zbuff” is determined with the depth model, the value is utilized to compute the camera motion vectors.

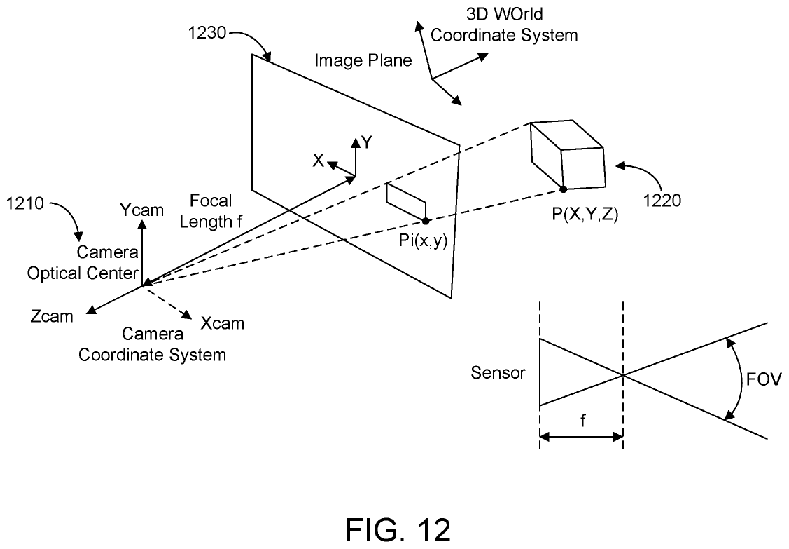

FIG. 12 illustrates principles of a pinhole camera model of a virtual camera in a cloud gaming system. The 3D engine uses a virtual camera 1210 to project the 3D scene 1220 onto a plane 1230 to generate a 2D image. In the pinhole camera representation, the physical characteristics of the camera (focal length, sensor size, field of view, . . . ) may be used to compute a projection matrix, which is the intrinsic matrix of the camera. This matrix defines a point Pi(x, y) in the 2D image where a point P(X,Y,Z) in the 3D space is projected. In the following, the matrix is referred to as the camera projection matrix and the 2D image as a game engine 2D rendered image.

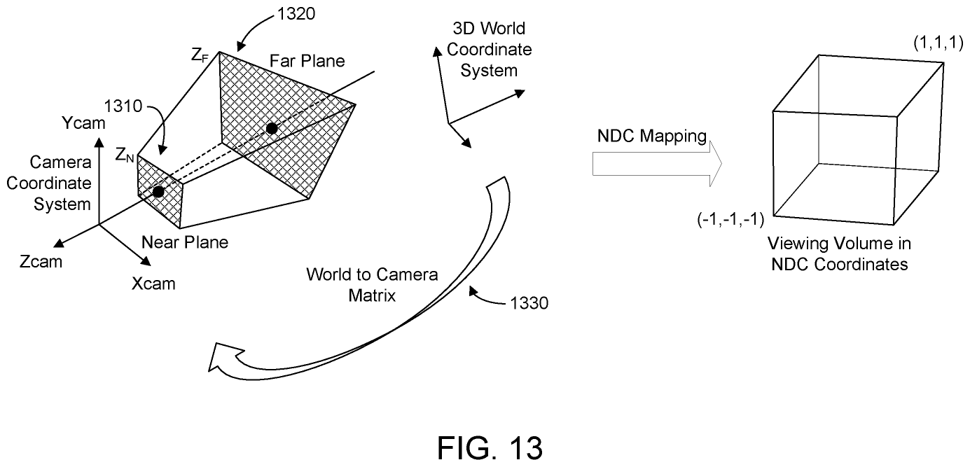

FIG. 13 illustrates projection planes of a virtual camera in a cloud gaming system. Indeed, unlike physical cameras that project objects distant from 0 to infinity, a virtual camera of a game engine projects the objects in between two projection planes: a near plane 1310 and a far plane 1320. It means that these two planes represent the minimal and maximal depth used for the rendering: the near plane 1310 is usually mapped to depth 0 and the far plane 1320 to depth 1.

However, according to a variant, the depth value associated with the far and near plane may be represented conversely. The camera projection matrix depends on the position of the planes 1310, 1320. The way this matrix is built is not described here, but well known in OpenGL or DirectX for instance. Besides, the camera projection matrix performs its projection relatively to its own coordinate system, the camera coordinate system as illustrated in FIG. 12 and FIG. 13.

Since the camera is not placed at the origin of a 3D world coordinate system, another matrix is required to convert the position of a 3D point from the 3D world coordinate system to the camera coordinate system. The world to camera matrix 1330 is utilized to represent the rotations and the translations of the camera relative to the 3D world coordinate system. The relationship between a 3D point in the game's 3D world and its 2D position in the 2D projected image is defined by the world to camera projection matrix 1330 and the camera projection matrix. Conversely, the position of a 2D image point can be linked to a 3D world point by the inverse projection matrix and the camera to world matrix. To achieve the reconstruction of a 3D world point from the 2D projected image, a third image coordinate Zbuff representing the depth value (here the approximated depth value computed from the depth model) is used for each sample of 2D projected image. The value Zbuff is the depth information provided by the game engine, as presented in FIG. 4 and FIG. 5.

FIG. 14 illustrates 2D to 3D transformations according to a general aspect of at least one embodiment. As shown in FIG. 14, 4 matrices [PM₁]⁻¹, [C₁toW], [WtoC₀] and [PM₀] representative of a change of coordinate system or projection/deprojection are used to compute a camera motion vector. The matrices are 4×4. The world to camera matrix [WtoC₀] and the projection matrix [PM₀] characterize the camera and its position with respect to the reference image I0. The camera to world matrix [C₁toW] and the inverse projection matrix [PM₁]⁻¹ corresponds to camera in the current image I1. The zbuf1 information representing the depth of a current sample P1 is also used.

A motion vector is computed that represents the motion of the current sample P1(x1, y1) in the current image I1 relatively to a corresponding sample P0(x0, y0) in the reference image I0. In a first step, the 3D position P(X,Y,Z) of P1 in the 3D world is computed using the 2D position of the sample P1(x1,y1) in the current image, the depth value zbuf1 of the sample P1, the matrices [PM₁]⁻¹, [C₁toW] respectively characterizing the inverse projection and the camera C1 to world matrix for the current image. In a second step, the 3D point is projected onto the reference image I0 using the matrices [WtoC₀] and [PM₀] respectively characterizing the camera C0 for the reference image and the projection in 2D reference image, the projection provides the point P0(x0, y0). The difference between the sample positions in the current image and the reference image provides the motion vector.

In a variant embodiment of the first step, the transformation of a 2D image point P1(x1, y1) of the current image to a point P in the 3D world as follows. The coordinates of the point P1(x1, y1) in the current image are expressed in Normalized Device Coordinates (NDC) in the range [−1,1] with 4 dimensions. The center of the image is [0,0]. The additional depth information zbuf1 representing the depth of the current sample P1 in the 3D scene is added as the third additional coordinates. The C1 inverse projection matrix [PM₁]⁻¹ and the C1 camera to world matrix [C₁toW] are applied to the 2D+1 coordinates of the point to obtain the coordinates in the 3D world. To be multiplied by the projection matrix, the 2D image point P1 must be expressed using a 4 dimensions vector in homogeneous coordinates for mathematical rational:

$${P}_{1} = {[ {x}_{1} , {y}_{1} , zbuf 1 , 1 ]}^{T}$$

Where x₁ is an horizontal coordinate in the range [−1,1] of P1 with respect to the center of the image, y₁ is a vertical coordinate in the range [−1,1] of P1 with respect to the center of the image, and zbuf1 is a depth coordinate in the range [−1,1] of P1 with respect to the 3D scene provided by the game engine. An intermediate 3D position represented by the vector [x_{cam1},y_{cam1},z_{cam1},w_{cam1}]^{T} is obtained from a de-projection of P1. The inverse projection matrix [PM₁]⁻¹ of the camera C1 is applied to the vector representing P1:

$${[ {x}_{c a m 1} , {y}_{c a m 1} , {z}_{c a m 1} , {w}_{c a m 1} ]}^{T} = {[ P {M}_{1} ]}^{- 1} * {[ {x}_{1} , {y}_{1} , zbuf 1 , 1 ]}^{T}$$

To represent a real 3D cartesian position, the fourth vector coordinate w_{cam1} should be equal to 1. The four coordinates [x′_{cam1},y′_{cam1},z′_{cam1},w′_{cam}1=₁]^{T} are thus normalized by dividing their values by w_{cam1}:

$${[ {x}_{c a m 1}^{′} , {y}_{c a m 1}^{′} , {z}_{c a m 1}^{′} , {w}_{c a m 1}^{′} = 1 ]}^{T} = {[ \frac{{x}_{cam 1}}{{w}_{cam 1}} , \frac{{y}_{cam 1}}{{w}_{cam 1}} , \frac{{z}_{cam 1}}{{w}_{cam 1}} , \frac{{w}_{cam 1}}{{w}_{cam 1}} ]}^{T}$$

Then, the camera C1 to world matrix [C₁toW] is applied to intermediate normalized 3D cartesian position to obtain the coordinates of the 3D point [X,Y,Z,W=1]^{T}:

$${[ X , Y , Z , W = 1 ]}^{T} = [ {C}_{1} to W ] * {[ {x}_{c a m 1}^{′} , {y}_{c a m 1}^{′} , {z}_{c a m 1}^{′} , {w}_{c a m 1} = 1 ]}^{T}$$

In a variant embodiment of the second step, the transformation of the point P in the 3D world into a point P0(x0, y0) of the 2D reference image is obtained as follows. The world to camera C0 matrix [WtoC0] is applied to the 4 dimensions vector representing the coordinates of the 3D point P to generate an intermediate position [x_{cam0},y_{cam0},z_{cam0},w_{cam0}=1]^{T}.

$${[ {x}_{c a m 0} , {y}_{c a m 0} , {z}_{c a m 0} , {w}_{c a m 0} = 1 ]}^{T} = [ W to C 0 ] * {[ X , Z , Y , W = 1 ]}^{T}$$

Then, the projection matrix [PM₀] is applied to intermediate position to obtain the coordinates in the 2D plane of the reference image as a 4 dimensions vector [x′₀,y′₀, z′₀, w′₀]^{T}:

$${[ {x}_{0}^{′} , {y}_{0}^{′} , {z}_{0}^{′} , {w}_{0}^{′} ]}^{T} = [ {PM}_{2} ] * {[ {x}_{c a m 0} , {y}_{c a m 0} , {z}_{c a m 0} , {w}_{c a m 0} = 1 ]}^{T}$$

The fourth coordinate w is normalized to obtain the position of 2D point P0(x0, y0) in the reference image:

$${[ {x}_{0} , {y}_{0} , {z}_{0} , {w}_{0} = 1 ]}^{T} = {[ \frac{{x}_{0}^{′}}{{w}_{0}^{′}} , \frac{{y}_{0}^{′}}{{w}_{0}^{′}} , \frac{{z}_{0}^{′}}{{w}_{0}^{′}} , \frac{{w}_{0}^{′}}{{w}_{0}^{′}} ]}^{T}$$

According to yet another variant embodiment of the camera motion information computation, a motion vector is determined between P1 and P0. The motion vector MV represents the vector to applied to a position P0 of a projected 3D point in the reference image to get the corresponding position P1 of the same 3D point projected in the current image. According the MV is obtained from the difference between the coordinates of the points P1(x1, y1) and P0(x0, y0) with:

$$MV \cdot x = x 0 - x 1 and$$

$$MV \cdot y = y 0 - y 1.$$

Even if the transformations required to compute the motion vectors have been detailed to help the understanding, in a variant, some optimizations may be performed to reduce the number of operations.

According to another variant embodiment, an indicator is signaled where the indicator specifies that determining motion information representative of camera motion for a coding block is enabled in the current image. Accordingly, the use of camera motion tool described above may be enabled or disabled by an indicator (e.g., a high-level syntax flag called for example “enable_camera_motion_tool”). This indicator may be signaled at picture or slice level in a picture header or a slice header. It may also be signaled at a sequence level (e.g., in SPS or PPS).

According to another variant embodiment, the indication on whether a block is a Camera Motion predicted block or not is signaled from the encoder to the decoder. For instance, the use of camera motion tool may be enabled or disabled at the CU level based on a CU level indicator (e.g., a flag called “camera_motion_flag”) as detailed in the tables below. In a variant, the depth parameters Pi may be directly signaled as indicated in bold in table 1.

TABLE 1
Example of Camera Motion signaling

| | Descriptor |
|---|---|
| Merge_data( x0, y0, cbWidth, cbHeight, chType ) { | |
| if( CuPredMode[ chType ][ x0 ][ y0 ] = = MODE_IBC ) { | |
| if( MaxNumIbcMergeCand > 1 ) | |
| merge_idx[ x0 ][ y0 ] | ae(v) |
| } else { | |
| camera_motion_flag[ x0 ][ y0 ] | ae(v) |
| if( camera_motion_flag[ x0 ][ y0 ] ) { | |
| camera_motion_depth[ x0 ][ y0 ] | u(32) |
| } | |
| if( MaxNumSubblockMergeCand > 0 && cbWidth >= 8 && cbHeight >= 8 && ! | |
| camera_motion_flag[ x0 ][ y0 ]) | |
| merge_subblock_flag[ x0 ][ y0 ] | ae(v) |
| if( merge_subblock_flag[ x0 ][ y0 ] = = 1 ) { | |
| if( MaxNumSubblockMergeCand > 1 ) | |
| merge_subblock_idx[ x0 ][ y0 ] | ae(v) |
| } else { | |
| if( cbWidth < 128 && cbHeight < 128 && | |
| ( ( sps_ciip_enabled_flag && cu_skip_flag[ x0 ][ y0 ] = = 0 && | |
| ! camera_motion_flag[ x0 ][ y0 ] && ( cbWidth * cbHeight ) >= 64 ) \| \| | |
| ( sps_gpm_enabled_flag && | |
| sh_slice_type = = B && cbWidth >= 8 && cbHeight >= 8 && | |
| cbWidth < ( 8 *cbHeight ) && cbHeight < ( 8*cbWidth ) ) ) ) | |
| regular_merge_flag[ x0 ][ y0 ] | ae(v) |
| if( regular_merge_flag[ x0 ][ y0 ] = = 1 ) { | |
| if( sps_mmvd_enabled_flag ) | |
| mmvd_merge_flag[ x0 ][ y0 ] | ae(v) |
| if( mmvd_merge_flag[ x0 ][ y0 ] = = 1 ) { | |
| if( MaxNumMergeCand > 1 ) | |
| mmvd_cand_flag[ x0 ][ y0 ] | ae(v) |
| mmvd_distance_idx[ x0 ][ y0 ] | ae(v) |
| mmvd_direction_idx[ x0 ][ y0 ] | ae(v) |
| } else if( MaxNumMergeCand > 1 ) | |
| merge_idx[ x0 ][ y0 ] | ae(v) |
| } else { | |
| if( sps_ciip_enabled_flag && sps_gpm_enabled_flag && | |
| sh_slice_type = = B && | |
| cu_skip_flag[ x0 ][ y0 ] = = 0 && cbWidth >= 8 && cbHeight >= 8 && | |
| cbWidth < ( 8 * cbHeight ) && cbHeight < ( 8 * cbWidth ) && | |
| cbWidth < 128 && cbHeight < 128 ) | |
| ciip_flag[ x0 ][ y0 ] | ae(v) |
| if( ciip_flag[ x0 ][ y0 ] && MaxNumMergeCand > 1 ) | |
| merge_idx[ x0 ][ y0 ] | ae(v) |
| if( !ciip_flag[ x0 ][ y0 ] ) { | |
| merge_gpm_partition_idx[ x0 ][ y0 ] | ae(v) |
| merge_gpm_idx0[ x0 ][ y0 ] | ae(v) |
| if( MaxNumGpmMergeCand > 2 ) | |
| merge_gpm_idx1[ x0 ][ y0 ] | ae(v) |
| } | |
| } | |
| } | |
| } | |
| } | |

The according semantics is described as:

camera_motion_depth[x0][y0] specifies the depth used by the camera motion mode where x0, y0 specify the location (x0, y0) of the top-left luma sample of the considered coding block relative to the top-left luma sample of the picture.

In a variant, the decoder may obtain an indication of the depth model used by the camera motion tool as detailed below in bold in table 2. The syntax may be similar to the syntax for instance used in merge mode (regular or affine merge mode).

TABLE 2
Example of Camera Motion signaling

| | Descriptor |
|---|---|
| merge_data( x0, y0, cbWidth, cbHeight, chType ) { | |
| if( CuPredMode[ chType ][ x0 ][ y0 ] = = MODE_IBC ) { | |
| if( MaxNumIbcMergeCand > 1 ) | |
| merge_idx[ x0 ][ y0 ] | ae(v) |
| } else { | |
| camera_motion_flag[ x0 ][ y0 ] | ae(v) |
| if( camera_motion_flag[ x0 ][ y0 ] ) { | |
| camera_motion_model[ x0][ y0 ] | ae(v) |
| if( camera_motion_model != Depth_Model1 ) { | |
| mvd_coding( x0, y0) | |
| } | |
| if( camera_motion_model != Depth_Model2V ) { | |
| mvd_coding( x0, y0) | |
| } | |
| if( camera_motion_model != Depth_Model12H) { | |
| mvd_coding( x0, y0) | |
| } | |
| if( camera_motion_model == Depth_Model3) { | |
| mvd_coding( x0, y0) | |
| } | |
| } | |
| if( MaxNumSubblockMergeCand > 0 && cbWidth >= 8 && cbHeight >= 8 && ! | |
| camera_motion_flag[ x0 ][ y0 ]) | |
| merge_subblock_flag[ x0 ][ y0 ] | ae(v) |
| if( merge_subblock_flag[ x0 ][ y0 ] = = 1 ) { | |
| if( MaxNumSubblockMergeCand > 1 ) | |
| merge_subblock_idx[ x0 ][ y0 ] | ae(v) |
| } else { | |
| if( cbWidth < 128 && cbHeight < 128 && | |
| ( ( sps_ciip_enabled_flag && cu_skip_flag[ x0 ][ y0 ] = = 0 && | |
| ! camera_motion_flag[ x0 ][ y0 ] && ( cbWidth * cbHeight ) >= 64 ) \| \| | |
| ( sps_gpm_enabled_flag && | |
| sh_slice_type = = B && cbWidth >= 8 && cbHeight >= 8 && | |
| cbWidth < ( 8 * cbHeight ) && cbHeight < ( 8 * cbWidth ) ) ) ) | |
| regular_merge_flag[ x0 ][ y0 ] | ae(v) |
| if( regular_merge_flag[ x0 ][ y0 ] = = 1 ) { | |
| if( sps_mmvd_enabled_flag ) | |
| mmvd_merge_flag[ x0 ][ y0 ] | ae(v) |
| if( mmvd_merge_flag[ x0 ][ y0 ] = = 1 ) { | |
| if( MaxNumMergeCand > 1 ) | |
| mmvd_cand_flag[ x0 ][ y0 ] | ae(v) |
| mmvd_distance_idx[ x0 ][ y0 ] | ae(v) |
| mmvd_direction_idx[ x0 ][ y0 ] | ae(v) |
| } else if( MaxNumMergeCand > 1 ) | |
| merge_idx[ x0 ][ y0 ] | ae(v) |
| } else { | |
| if( sps_ciip_enabled_flag && sps_gpm_enabled_flag && | |
| sh_slice_type = = B && | |
| cu_skip_flag[ x0 ][ y0 ] = = 0 && cbWidth >= 8 && chHeight >= 8 && | |
| cbWidth < (8 * cbHeight ) && cbHeight < ( 8 * cbWidth ) && | |
| cbWidth < 128 && cbHeight < 128 ) | |
| ciip_flag[ x0 ][ y0 ] | ae(v) |
| if( ciip_flag[ x0 ][ y0 ] && MaxNumMergeCand > 1 ) | |
| merge_idx[ x0 ][ y0 ] | ae(v) |
| if( !ciip_flag[ x0 ][ y0 ] ) { | |
| merge_gpm_partition_idx[ x0 ][ y0 ] | ae(v) |
| merge_gpm_idx0[ x0 ][ y0 ] | ae(v) |
| if( MaxNumGpmMergeCand > 2 ) | |
| merge_gpm_idx1[ x0 ][ y0 ] | ae(v) |
| } | |
| } | |
| } | |
| } | |
| } | |

The according semantics is described as:

camera_motion_model[x0][y0] specifies the depth model used in camera motion among the Depth Model1, Depth Model2V, Depth Model2H, Depth Model3 where x0, y0 specify the location (x0, y0) of the top-left luma sample of the considered coding block relative to the top-left luma sample of the picture.

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 275, 375), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation; RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining a coding block in a current image, wherein the current image is part of a game engine two-dimensional (2D) rendered video;
obtaining at least one parameter of a depth model for the coding block, wherein the at least one parameter of the depth model define a plane representative of depth values;
obtaining camera parameters for the current image;
obtaining camera parameters for a reference image;
determining motion information for at least one sample in the coding block of the current image to be coded in inter with respect to the reference image, wherein motion information is determined from the at least one parameter of the depth model and from the camera parameters, and motion information is representative of camera motion between the current image and the reference image; and
encoding the coding block based on the motion information.

2. The method of claim 1, wherein a depth model for the coding block includes a plane parallel to a camera's sensor and is characterized by one depth parameter.

3. The method of claim 2, wherein the one depth parameter is representative of a depth value of a central sample of the coding block.

4. The method of claim 1, wherein a depth model for the coding block includes a plane tilted vertically or horizontally with respect to a camera's sensor and is characterized by two depth parameters.

5-6. (canceled)

7. The method of claim 1, wherein a depth model for the coding block includes a plane tilted vertically and horizontally with respect to a camera's sensor and is characterized by three depth parameters.

8-16. (canceled)

17. A method, comprising:
obtaining a coding block in a current image, wherein the current image is part of a game engine two-dimensional (2D) rendered video;
obtaining at least one parameter of a depth model for the coding block, wherein the at least one parameter of the depth model define a plane representative of depth values;
obtaining camera parameters for the current image;
obtaining camera parameters for a reference image;
determining motion information for at least one sample in the coding block of the current image coded in inter with respect to a reference image, wherein motion information is determined from the at least one parameter of the depth model for the coding block and the camera parameters, and wherein motion information is representative of camera motion between the current image and the reference image; and
decoding the coding block based on the motion information.

18. The method of claim 17, wherein a depth model for the coding block includes a plane parallel to a camera's sensor and is characterized by one depth parameter.

19. The method of claim 18, wherein the one depth parameter is representative of a depth value of a central sample of the coding block.

20. The method of claim 17, wherein a depth model for the coding block includes a plane tilted vertically or horizontally with respect to a camera's sensor and is characterized by two depth parameters.

21-22. (canceled)

23. The method of claim 17, wherein a depth model for the coding block includes a plane tilted vertically and horizontally with respect to a camera's sensor and is characterized by three depth parameters.

24-30. (canceled)

31. An apparatus comprising a memory and one or more processors, wherein the one or more processors are configured to:
obtain a coding block in a current image, wherein the current image is part of a game engine two-dimensional (2D) rendered video;
obtain at least one parameter of a depth model for the coding block, wherein the at least one parameter of the depth model define a plane representative of depth values;
obtain camera parameters for the current image;
obtain camera parameters for a reference image;
determine motion information for at least one sample in the coding block of the current image to be coded in inter with respect to the reference image, wherein motion information is determined from the at least one parameter of the depth model and from the camera parameters, and motion information is representative of camera motion between the current image and the reference image; and
encode the coding block based on the motion information.

32. The apparatus of claim 31, wherein a depth model for the coding block includes a plane parallel to a camera's sensor and is characterized by one depth parameter.

33. The apparatus of claim 32, wherein the one depth parameter is representative of a depth value of a central sample of the coding block. of samples of a subsampled coding block.

34. The apparatus of claim 31, wherein a depth model for the coding block includes a plane tilted vertically or horizontally with respect to a camera's sensor and is characterized by two depth parameters.

35-36. (canceled)

37. The apparatus of claim 31, wherein a depth model for the coding block includes a plane tilted vertically and horizontally with respect to a camera's sensor and is characterized by three depth parameters.

38-46. (canceled)

47. An apparatus comprising a memory and one or more processors, wherein the one or more processors are configured to:
obtain a coding block in a current image, wherein the current image is part of a game engine two-dimensional (2D) rendered video;
obtain at least one parameter of a depth model for the coding block, wherein the at least one parameter of the depth model defines a plane representative of depth values;
obtain camera parameters for the current image;
obtain camera parameters for a reference image;
determine motion information for at least one sample in the coding block of the current image coded in inter with respect to a reference image, wherein motion information is determined from the at least one parameter of the depth model and the camera parameters, and wherein motion information is representative of camera motion between the current image and the reference image; and
decode the coding block based on the motion information.

48. The apparatus of claim 47, wherein a depth model for the coding block includes a plane parallel to a camera's sensor and is characterized by one depth parameter.

49. The apparatus of claim 48, wherein the one depth parameter is representative of a depth value of a central sample of the coding block.

50. The apparatus of claim 47, wherein a depth model for the coding block includes a plane tilted vertically or horizontally with respect to a camera's sensor and is characterized by two depth parameters.

51-52. (canceled)

53. The apparatus of claim 47, wherein a depth model for the coding block includes a plane tilted vertically and horizontally with respect to a camera's sensor and is characterized by three depth parameters.

54-65. (canceled)
